(19) United States
(12) Patent Application Publication
(10) Pub. No.: US 2019/0072807 A1
(43) Pub. Date: Mar. 7, 2019

(54) STIMULI-DRIVEN DYNAMIC RECONFIGURABLE HELICAL SUPERSTRUCTURES, AND COMPOSITIONS AND USES THEREOF

(71) Applicants: Kent State University, Kent, OH (US); Government of the United States as Represented by the Secretary of the Air Force, Wright-Patterson AFB, OH (US)

(72) Inventors: Quan Li, Stow, OH (US); Timothy J. Bunning, Beavercreek, OH (US); Zhi-gang Zheng, Kent, OH (US); Yannian LIi, Monroeville, PA (US); Hari Krishna Bisoyi, Kent, OH (US); Ling Wang, Kent, OH (US)

(73) Assignees: Kent State University, Kent, OH (US); Government of the United States as Represented by the Secretary of the Air Force, Wright-Patterson AFB, OH (US)

(21) Appl. No.: 16/081,960

(22) PCT Filed: Mar. 6, 2017
(86) PCT No.: PCT/US17/20850

§ 371 Date: Sep. 4, 2018

Related U.S. Application Data
(60) Provisional application No. 62/303,617, filed on Mar. 4, 2016.

(51) Int. Cl. G02F 1/137; G02F 1/1337; G02F 1/1343; G02F 1/29

(52) U.S. Cl. CPC G02F 1/13718; G02F 1/133711; G02F 2203/62; G02F 1/292; G02F 1/134363

(57) ABSTRACT

A dynamic self-organized helical superstructure device includes a chiral material and a liquid crystal material disposed between first and second substrates. The helical superstructure is reversibly switchable upon the application of at least one external stimulus from one state to another state among three states: a standing helix, a uniform lying helix, and an in-plane rotation state.

### CROSS-REFERENCE TO RELATED APPLICATIONS

This application claims the priority benefit of U.S. Provisional Application Ser. No. 62/303,617, filed Mar. 4, 2016, the contents of which are incorporated by reference herein.

### STATEMENT REGARDING FEDERALLY SPONSORED RESEARCH

This invention was made with government support under Grant No. FA9950-09-1-0193 awarded by the Air Force Office of Scientific Research. The government has certain rights in the invention.

### BACKGROUND

The present disclosure relates to a stimulus-responsive dynamic self-organized helical superstructure device, materials thereof and methods thereof.

Chiral nematic liquid crystals—otherwise referred to as cholesteric liquid crystals (CLCs)—are self-organized helical superstructures that have practical application in, for example, thermography, reflective displays, tuneable color filters, and mirrorless lasing. Dynamic, remote and three-dimensional control over the helical axis of CLCs is desirable, but challenging. For example, the orientation of the helical axis relative to the substrate can be changed from perpendicular to parallel by applying an alternating current electric field, by changing the anchoring conditions of the substrate, or by altering the topography of the substrate's surface; separately, in-plane rotation of the helical axis parallel to the substrate can be driven by a direct-current field.

It would be desirable to develop new systems and methods for controlling the helical axis of CLCs.

### BRIEF DESCRIPTION

Disclosed, in some embodiments, is a dynamic self-organized helical superstructure device, including: a chiral material and a liquid crystal material disposed between first and second transparent substrates. The helical superstructure is reversibly switchable, upon application of at least one external stimulus, from one state to another state among three states: a) a standing helix state, b) a uniform lying helix state; and c) an in-plane rotation state.

In some embodiments, the external stimulus is selected from the group consisting of light, an electric field, a magnetic field, a temperature, a mechanical force, a chemical reaction, and mixtures thereof.

The chemical reaction may be an electrochemical reaction.

In some embodiments, the light stimulus is electromagnetic radiation selected from the group consisting of gamma ray radiation, X-ray radiation, UV light radiation, visible light radiation, infrared radiation, and mixtures thereof.

The helical twisting power of the chiral material may be changeable upon exposure to the external stimulus.

In some embodiments, the chiral material is photoresponsive azobenzene, dithienylcyclopentene, spiropyran, fulgide, overcrowded alkyne, or thioindigo derivative.

The chiral material may be photoswitchable but thermally stable or thermally reversible.

In some embodiments, the liquid crystal material comprises at least one nematic liquid crystal component.

The helical superstructure may be photoresponsive accompanied with handedness inversion upon exposure to the external stimulus.

In some embodiments, the helical superstructure is configurable from standing helix state to lying helix state reversibly or irreversibly upon light irradiation.

The helical superstructure may exhibit in-plane rotation reversibly or irreversibly upon light irradiation.

In some embodiments, the helical superstructure is reversibly switchable among the three states upon light irradiation.

The helical superstructure may include a chiral liquid crystal, a liquid crystal polymer, and a helical biological system.

In some embodiments, the device is a two-dimensional beam steering device, a diffraction array controllable device, or a spectrum scanning device.

These and other non-limiting characteristics are more particularly described below and in the appended materials.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a flow chart illustrating reversible, light-induced, three-dimensional control over the direction of a helical axis in accordance with some embodiments of the present disclosure.

FIG. 2 illustrates the molecular structure of (S,S)-D4, a photodynamic, switchable, chiral material with thermal stability.

FIG. 3 illustrates an embodiment of light-driven 2D beam steering by in-plane rotation of the helical access.

FIG. 4 illustrates an embodiment of light-driven reversible transformation among 1D-, 2D-diffraction patterns and diffraction off-state.

### DETAILED DESCRIPTION

The present disclosure may be understood more readily by reference to the following detailed description of desired embodiments included therein and the appended article, supplementary materials, and presentation slides. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure relates to a stimulus-responsive dynamic self-organized helical superstructure device, materials thereof and methods thereof. It finds particular application in conjunction with a controllable reconfiguration of helical superstructure directed by external stimuli such as light, electric field and temperature, and stimuli-driven two-dimensional beam steering and diffraction array controllable device. The helical superstructure can be reversibly manipulated through external stimuli from one state to another state among three states: a) a standing helix; b) a uniform lying helix; and c) an in-plane rotation. Such properties enable many exciting applications in the fields of photonics, nanotechnology and biology.

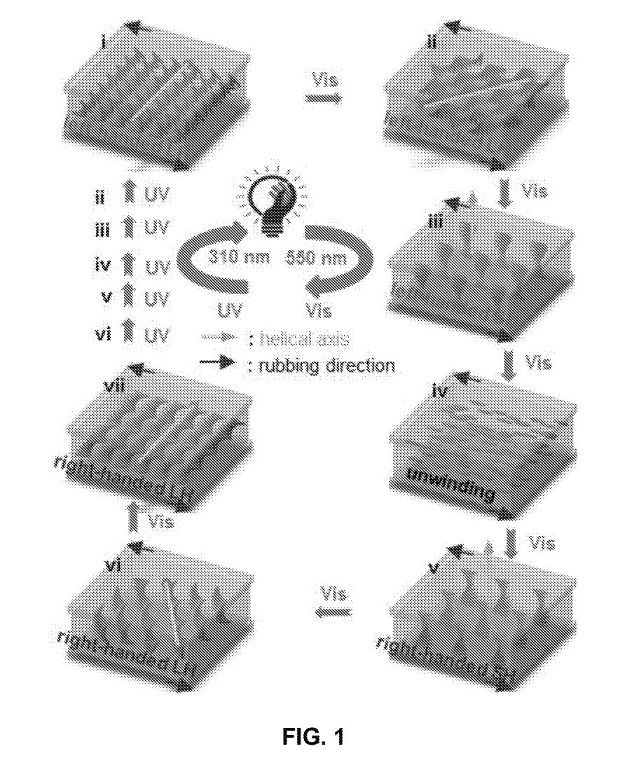

FIG. 1 illustrates a non-limiting embodiment of a method in accordance with some embodiments of the present disclosure. In particular, reversible, light-induced, three-dimensional control over the direction of the helical axis is shown. After the left-handed lying helix (LH) is obtained by UV exposure (i), the sample is triggered by visible light (vis, 550 nm)—producing, in sequence, a clockwise in-plane rotation (ii); transformation from the left-handed LH to left-handed standing helix (SH) organization (iii); unwinding of the left-handed SH to generate a homogeneous alignment (iv); and reappearance of the right-handed SH arrangement (v). Further stimulation with visible light causes the right-handed standing helices to lie down again (vi), and then to form the right-handed lying helices and to rotate clockwise in-plane (vii) when the system reaches the visible photostationary state. This whole process can then be driven backwards to the original state by UV light irradiation. This reversible sequence of events in a continuous process establishes the three-dimensional manipulation of the helical axis (see Q. Li, et al. Nature 2016, 531, 352-356).

The present disclosure relates to the three-dimensional manipulation of the helical axis of a CLC, together with inversion of its handedness. In some embodiments, this is achieved solely with a light stimulus. This technique may be used to carry out light-activated, wide-area, reversible two-dimensional beam steering-previously accomplished using complex integrated systems and optical phased arrays. During the three-dimensional manipulation by light, the helical axis undergoes, in sequence, a reversible transition from perpendicular to parallel to the substrate surface, followed by in-plane rotation on the substrate surface. Such reversible manipulation depends on experimental parameters such as cell gap, surface anchoring condition, and pitch length. In general, thicker cell gap and stronger surface anchoring lead a weaker manipulation of liquid crystal molecules upon external stimulations. The cell-to-gap pitch ratio (d/p) may be close to integer multiples of 0.5 when lying helix can be delicately obtained. Because there is no thermal relaxation, the system can be driven either forwards or backwards from any light-activated intermediate state. Also disclosed herein is reversible photocontrol between a two-dimensional diffraction state, a one-dimensional state and a diffraction ‘off’ state in a bilayer cell.

According to Bragg's law, when CLCs are in a planar cell—and hence their helices are in ‘standing helix’ (SH) orientation, perpendicular to the substrate—modulating the helical pitch length produces tuneable, selective reflection of circularly polarized light. In contrast, CLCs in a homeotropic cell—where the helical axes are in ‘lying helix’ (LH) orientation, parallel to the substrate's surface, but randomly oriented—exhibit a fingerprint optical texture. Such an LH arrangement has allowed rotational manipulation of microscale objects on the surface of CLC films. On the other hand, a uniform LH arrangement: in which the helical axes are oriented along a single direction, produces an optical texture of uniform periodic stripes perpendicular to the helical axis, and possesses an in-plane, periodic modulation of the refractive index along the helical axis. An “in-plane rotation state” refers to a state where the helical axis of the CLC rotates in the plane of the cell substrate surfaces (i.e., it is more like a two-dimensional rotation). Varying the pitch length of the uniform LH arrangement can modulate the diffraction angle, enabling non-mechanical beam steering and spectrum scanning along a one-dimensional line. A wide in-plane rotation angle of the helical axis has been produced in a hybrid cell (with one substrate treated for vertical alignment, the other for homogeneous alignment) by light irradiation, but the helical axis could not be transformed from the LH to the SH state. Other work has used independent external stimuli to transform standing helices to lying helices, or to achieve in-plane rotation of uniform lying helices.

Disclosed, in some embodiments, is a dynamic self-organized helical superstructure device, comprising: a chiral material and a liquid crystal material disposed between first and second transparent substrates; wherein the helical superstructure is reversibly switchable, upon application of at least one external stimulus, from one state to another state among three states: a) a standing helix state, b) a uniform lying helix state; and c) an in-plane rotation state.

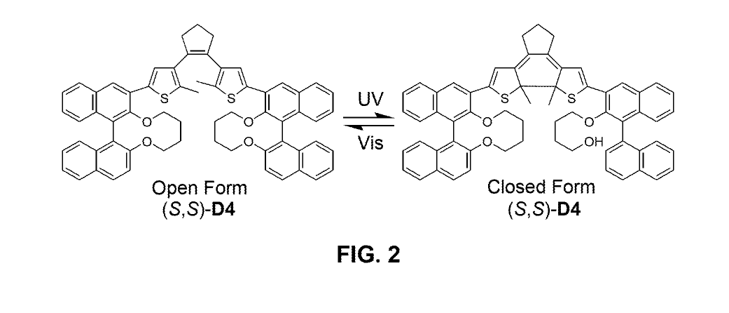

The chiral material may be selected from azobenzene and dithienylcyclopentene derivative. In some embodiments, the chiral material is a dithienylcyclopentene material (S,S)-D4 which undergoes ring closure and ring open upon irradiation with ultraviolet (UV) and visible light, respectively. The molecular structure of (S,S)-D4 is illustrated in FIG. 2.

The chiral material may be present in an amount of from about 0.1 wt % to about 25 wt % of the weight of the liquid crystal layer.

The liquid crystal material may be an achiral nematic liquid crystal. In some embodiments, the liquid crystal is E7.

The liquid crystal material may be present in an amount of from about 75 wt % to about 99.9 wt % of the weight of the liquid crystal layer.

The first and second transparent substrates may independently include one or more of tin oxide, tin oxide doped with Sb, F or P, indium oxide, indium oxide doped with Sn and/or F, antimony oxide, zinc oxide and a noble metal. The substrate may include one or more of a glass plate, quartz plate, plastic plate, and polymer plate. The first and/or second transparent substrates may include an alignment layer.

The transparent substrates may have the same thickness or differing thicknesses. In some embodiments, the thickness of each transparent substrate is independently within the range of about 10 nm to about 1 mm, including from about 40 μm to about 500 μm. In some embodiments, the transparent substrates are PMMA polymer films.

The external stimulus may be selected from light, an electric field, a magnetic field, a temperature change, an applied mechanical force, a chemical reaction, and any combination of the aforementioned.

The external stimulus may be selected from gamma ray radiation, X-ray radiation, UV light radiation, visible light radiation, infrared radiation, and any combination of the aforementioned.

The external stimulus may be an electric field with different waveforms and/or with different status as DC or AC field.

The external stimulus may be a magnetic field of a geomagnetic field, electric-magnetic field or solely a permanent magnet.

The external stimulus may be temperature or a mechanical force applied to the liquid crystal cell within the boundaries of keeping the CLC structure from unwinding.

The external stimulus may be one or more chemical reactions leading to stimulus of light generation, electric field or magnetic field variation, temperature or mechanical force transformation, and so on.

In some embodiments of the present disclosure, light is used to induce both events sequentially—transformation of the SH to the uniform LH arrangement, followed by in-plane rotation-enabling three-dimensional control over the helical axis.

A dithienylcyclopentene-based, axially chiral molecular switch (S,S)-D4 as the dopant (1.2 mol %) in the commercially available achiral nematic liquid crystal E7 which is a eutectic mixture of liquid crystal components commercially designed for display applications, to fabricate a self-organized, optically-tuneable CLC. The helical twisting power (HTP) of (S,S)-D4 in E7 has previously been determined in a wedge cell; a texture transition of such a CLC confined in a homeotropic cell has also been observed, although no reversible SH-to-LH transition and in-plane rotation of the LH have previously been found. This axially chiral switch shows excellent fatigue resistance, with superior thermal stability in both its ring open and its ring-closed states. Upon irradiation with ultraviolet light at 310 nm, the ring-open structure is transformed into the ring-closed isomer; the helical superstructure changes handedness, from the initial right-handed to a left-handed form; and the HTP is enhanced. The reverse process occurs upon irradiation with visible light (e.g., at 550 nm).

A photoresponsive CLC was homogeneously filled into a planar cell (where the rubbing directions of the two substrates were aligned antiparallel to each other, and the cell gap, that is the gap between the top and bottom substrates, was 3.7±0.1 μm). Then, a polarizing optical microscope in transmission mode was used to study the sample. Initially, it was in a bright state, indicating the expected Grandjean planar texture—standing helices. Upon irradiation with ultraviolet light for 5 seconds, the bright state transformed into a dark state, corresponding to the unwound nematic phase, resulting from the homogeneous alignment of liquid-crystal (LC) molecules (parallel to the polarization direction of incident light). After 10 seconds of irradiation, the bright state reappeared (indicating the emergence of standing helices with opposite handedness), followed by the appearance of the periodic stripes that indicate a uniform LH arrangement, and accompanied by simultaneous in-plane rotation of the stripes and pitch contraction until the system reached the photostationary state (PSS). In contrast with aforementioned work, here the uniform LH arrangement was formed only by light irradiation. This LH structure can be erased and driven reversibly with visible light irradiation, as follows: the stripes rotate in the opposite direction; the distance between two adjacent stripes increases; the helices align perpendicularly, producing a left-handed SH arrangement; this left-handed structure unwinds and reorganizes to produce the right-handed SH arrangement; and eventually the uniform LH texture of the right-handed CLC is regenerated. Thus, the direction of the helical axis of CLCs can be manipulated in three dimensions solely by light. Moreover, the CLC system in any stimulated intermediate state is stable, without showing thermal relaxation, because of the thermal stability of the chiral molecular switch in both of its isomeric states.

The light-induced uniform LH arrangement might be produced in two main ways: first, through development of a large oblique or a vertical alignment of the LC molecules (this would benefit LH formation by coupling with the chiral effects); and second, through sufficient surface anchoring to maintain the orientation of the stripes in a single direction (achieved by planar surface anchoring of the cell). To investigate these possibilities, molecular-dynamics simulations of the photoresponsive CLC were performed; the results were consistent with Landau-de Gennes' elastic theory. Specifically, the results indicated an oblique alignment of LC molecules, resulting from the coupling of the elastic energy with the molecular interactions between the chiral switch and LC molecules during photoisomerization. The cell-gap-to-pitch ratio (d/P) is another critical factor in LH formation, and represents the coupling effects from the surface anchoring and the twist elastic energy. The measured value of d/P was very close to integer multiples of 0.5, implying that the LH was obtained only when an appropriate trade-off was reached between the surface anchoring and twist elastic energy. The propensity to form a uniform LH arrangement decreased as the d/P value increased.

The direction of the helical axis in the LH arrangement was determined by the azimuthal angle of the director of LC molecules in the middle layer of the cell; changes in this angle lead to the light-induced in-plane rotation of the helical axis. After photoisomerization, the chiral switch underwent a dramatic change in its molecular structure, which would cause a large change in the LC direction in the middle layer, leading to substantial in-plane rotation of the helical axis. However, the rotation of the helical axis can be suppressed when the LC direction is strongly pinned using an applied electric field. If the surface anchoring is too weak to resist the external disturbance, the formation of the uniform LH arrangement appears not to be favorable, or the conventional polydomain fingerprint texture of the CLC is generated. Planar anchoring with a smaller cell gap seems to be favorable for realizing three-dimensional dynamic photocontrol of the CLC helix. Thus, the three-dimensional manipulation of the helical axis depends on a delicate interplay among cell gap, surface anchoring, pitch length and external stimuli. To investigate potential applications of this light-induced, three-dimensional manipulation of the helical axis, non-mechanical two-dimensional (in-plane) beam steering was explored and a chromatic dispersion was observed as a collimated white probe light impinged on the uniform LH arrangement along the cell normal. Stimulation with ultraviolet light led to a simultaneous change in helical pitch and in-plane rotation of the stripes of the LH (rotation of the grating vector)—causing the diffraction angle of every wavelength to vary, and enabling two-dimensional in-plane beam steering, which can potentially be applied in spectrum scanning.

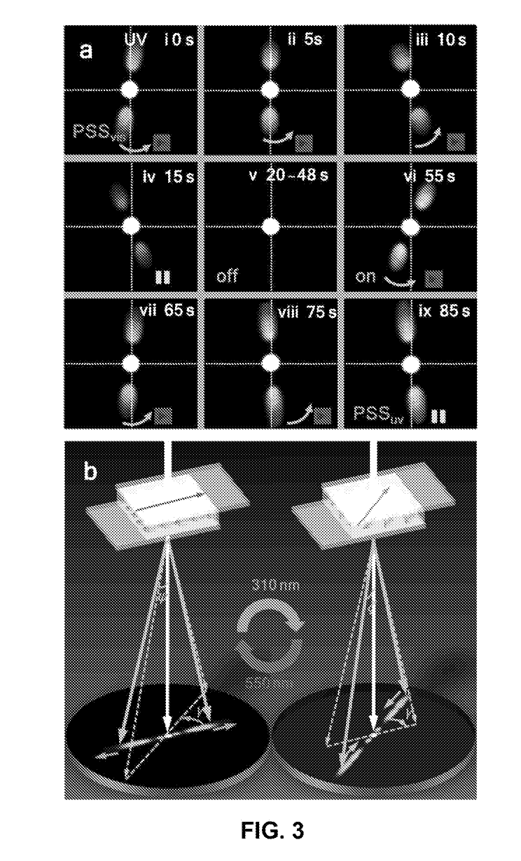

FIG. 3 illustrates an embodiment of light-controllable two-dimensional beam steering for spectrum scanning. The chromatic dispersion was gradually eliminated by continuous irradiation, because of the decreasing diffraction angle of every wavelength resulting from elongation of the helical pitch. At a time stamp of 20-48 seconds, the diffraction had disappeared, because the uniform LH arrangement had transformed into either the SH structure or the unwound homogeneous alignment. Upon further irradiation (to 55 seconds), the LH arrangement with the opposite handedness re-formed and rotated, diffraction reappeared, and the diffraction angle increased gradually owing to compression of the CLC pitch, until the sample reached the PSS. Overall, a wide two-dimensional scanning range of about 52°×8° was enabled, which is substantially larger than that of 23°×3.6° reported recently. Such wide, non-mechanical beam steering is desirable for free-space optical communication, adaptive-optics systems and phased-array radar.

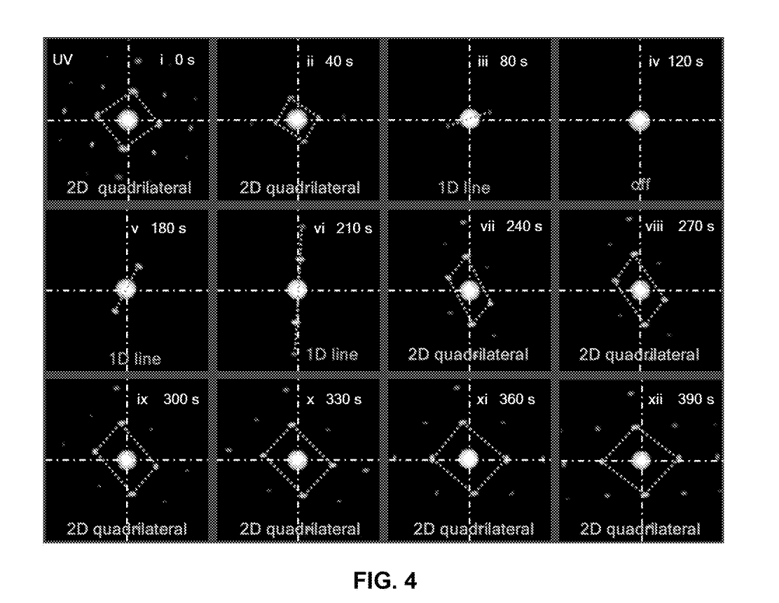

FIG. 4 illustrates an embodiment of light-induced diffraction dimensionality transformation of a bilayer CLC sample. The manipulation and deformation of a two-dimensional beamspot array is an interesting and challenging task, although metastable two-dimensional gratings have been encountered by chance, and an electric-field-induced two-dimensional grating in a cholesteric polymer system has been reported. A reversible dimensionality transformation—from a stable two-dimensional diffraction pattern, via a one-dimensional pattern was achieved in accordance with some embodiments of the present disclosure, to a diffraction off-state—by irradiating a specially designed, LC bilayer cell containing two thin, stacked LH layers (in which the surface directions of the adjacent layers were perpendicular). When one LH arrangement is converted to either an SH arrangement or a homogeneous alignment through irradiation, the diffraction pattern converts from a two-dimensional grid to a one-dimensional line to a direct transmission pattern (indicating the diffraction off-state). Further exposure leads to handedness inversion and thus to a reappearance of the LH structures, yielding first a one-dimensional diffraction pattern, and finally the two-dimensional pattern. The deformation of the envelope area and of the interior angles of the rhomboidal quadrilateral arises from the photomodulation of the CLC pitch and in-plane rotation of the helical axis. The time sequence of these changes is due to a progressive fall in the intensity of light, occurring because of photo-absorption by the chiral switch when light passes through the bilayer cell.

The conventional one-dimensional diffraction pattern emanates from one uniform LH layer of the bilayer cell, whereas the two-dimensional diffraction pattern develops as a result of combined diffraction effects from two adjacent LH layers. The initial two-dimensional grating arises from two right-handed LH layers whereas the reappeared two-dimensional diffraction pattern results from two left-handed uniform LH layers. It is also conceivable that the one-dimensional diffraction pattern might be switched on or off by changing the incident direction of the probe laser—analogous to the effect of a diode on current—which might enable new optical devices.

The systems and methods of the present disclosure may achieve light-induced, three-dimensional control of the helical axis of self-organized CLCs, resulting in a reversible transformation between an SH and a uniform LH arrangement, with control of both the in-plane rotation angle of the helical axis and the pitch length. This enables reversible, light-driven, wide-area, two-dimensional in-plane beam steering. Moreover, a light-induced reversible transformation between two-dimensional and one-dimensional diffraction patterns and a diffraction off-state was achieved by irradiating a bilayer LC cell. The absence of thermal relaxation for this chiral switch enables on-demand, digital control of both the beam direction and the dimensionality of the diffraction array, starting from any desired state and effected exclusively by light. The systems and methods of the present disclosure may enable the production of complex, light-activated smart systems and dynamic, reconfigurable three-dimensional architectures.

The following examples are provided to illustrate the devices and methods of the present disclosure. The examples are merely illustrative and are not intended to limit the disclosure to the materials, conditions, or process parameters set forth therein.

### EXAMPLES

### Example 1

### Tunable Two-Dimensional Beam Steering Based Chiral Liquid Crystal by Light

Due to the 2D in-plane rotation of the helix direction and accompanied by the pitch tuning through the light irradiation, the 2D beam steering was achieved and its performance on chromatic dispersion in 2D plane was observed. In addition, owing to the reversible rotation of the helical axis out of the plane, the performance of 2D beam steering can be turned on and off. The whole process was controlled only though the light. Compared with the very recent work of 2D beam scanning, based on the complicated manufacture process and high technological conditions, using more than 150 sophisticated optical elements, such light tunable two-dimensional beam steering exhibited more convenient fabrication, manipulation, and even much larger scanning range.

### Example 2

### Light Controllable Diffraction Array Device Based on Chiral Liquid Crystal

Changing the single layer thin cell (generally used as the transparent thin chamber, filled with the material by capillarity) as a designed bilayer cell, injecting the material into two gaps of the bilayer cell, and irradiating the cell, the dimensionality transformation of the diffraction patterns, from 2D to 1D, and turn off the diffraction performance, subsequently reappearance 1D diffraction, and consequently change to the 2D, was achieved due to the asynchronization of the rotation of helix direction in 3D. Another interesting aspect is the distribution of 2D diffraction pattern varies during the light irradiation, owing to the coupling effect of the axis rotation and the pitch length changing. Such dimensionality as well as the diffraction array controllable diffraction devices based on the light reconfigurations of self-organized soft superstructure is completely different from the conventional diffraction devices with a fixed dimensionality and array distribution fabricated with the photolithography or holography using the general optical materials or some other smart controllable materials.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A dynamic self-organized helical superstructure device, comprising:
a chiral material and a liquid crystal material disposed between first and second transparent substrates;
wherein the helical superstructure is reversibly switchable, upon application of at least one external stimulus, from one state to another state among three states: a) a standing helix state, b) a uniform lying helix state; and c) an in-plane rotation state.

2. The device of claim 1, wherein said external stimulus is selected from the group consisting of light, an electric field, a magnetic field, a temperature, a mechanical force, a chemical reaction, and mixtures thereof.

3. The device of claim 2, wherein the chemical reaction is an electrochemical reaction.

4. The device of claim 2, wherein said light stimulus is electromagnetic radiation selected from the group consisting of gamma ray radiation, X-ray radiation, UV light radiation, visible light radiation, infrared radiation, and mixtures thereof.

5. The device of claim 1, wherein a helical twisting power of chiral material is changeable upon exposure to the external stimulus.

6. The device of claim 4, wherein the chiral material comprises at least one photoresponsive chiral component.

7. The device of claim 6, wherein the photoresponsive chiral material is thermally stable or thermally reversible.

8. The device of claim 4, wherein the chiral material is an azobenzene material or a dithienylcyclopentene material.

9. The device of claim 1, wherein the liquid crystal material comprises at least one nematic liquid crystal component.

10. The device of claim 1, wherein the helical superstructure is photoresponsive accompanied with handedness inversion upon exposure to the external stimulus.

11. The device of claim 1, wherein the helical superstructure is configurable from standing helix to lying helix reversibly or irreversibly upon light irradiation.

12. The device of claim 1, wherein the helical superstructure is in-plane rotation reversibly or irreversibly upon light irradiation.

13. The device of claim 1, wherein the helical superstructure is reversibly switchable among the three states upon light irradiation.

14. The device of claim 1, wherein the helical superstructure comprises a chiral liquid crystal, a polymer, and a helical biological system.

15. The device of claim 1, wherein the device is a two-dimensional beam steering device, a diffraction array controllable device, or a spectrum scanning device.

16. The device of claim 1, wherein the first transparent substrate and the second transparent substrate independently comprise at least one material selected from the group consisting of:
tin oxide;
tin oxide doped with antimony, fluorine, or phosphorous;
indium oxide;
indium oxide doped with tin and/or fluorine;
antimony oxide;
zinc oxide; and
a nobel metal.

17. The device of claim 16, wherein the first transparent substrate and the second transparent substrate independently comprise a glass plate, a quartz plate, a plastic plate, or a polymer plate.

18. The device of claim 17, wherein an alignment layer is coated on the first transparent substrate.

19. The device of claim 17, wherein an alignment layer is coated on the second transparent substrate.

20. The device of claim 17, wherein a first alignment layer is coated on the first transparent substrate; and wherein a second alignment layer is coated on the second transparent substrate.
